(19) United States
(12) Patent Application Publication
(10) Pub. No.: US 2015/0181911 A1
(43) Pub. Date: Jul. 2, 2015

(54) FEEDSTOCK-DERIVED COMPOSITIONS AND PROCESSES OF MAKING SAME

(71) Applicant: POET Research, Inc., Sioux Falls, SD (US)

(72) Inventor: Steven G. Redford, Brandon, SD (US)

(73) Assignee: POET Research, Inc., Sioux Falls, SD (US)

(21) Appl. No.: 14/599,329

(22) Filed: Jan. 16, 2015

Related U.S. Application Data
(63) Continuation of application No. PCT/US13/49492, filed on Jul. 6, 2013.
(60) Provisional application No. 61/672,636, filed on Jul. 17, 2012.

(51) Int. Cl. A23K 1/06; A23K 1/00

(52) U.S. Cl. CPC A23K 1/06; A23K 1/001

(57) ABSTRACT

Feed compositions and methods of making feed compositions are disclosed herein. The feed compositions may include, on a dry weight basis, crude protein in an amount of about 40 wt % or greater, crude fat in an amount of up to about 20 wt %, neutral detergent fiber in an amount of up to about 20 wt %, and lysine in an amount of about 2.55 wt % or greater. The methods involve separating a beer composition produced by a starch-based feedstock-to-ethanol conversion process into bulk solids and a fine solids, and removing liquid from the fine solids, in which the separating and removing are performed in a manner that reduces the total heat exposure of the fine solids as compared to processes relying on distillation to separate beer components and/or cooking to saccharify starch.

### CROSS-REFERENCE TO RELATED APPLICATIONS

This application is a continuation of International Application No. PCT/US2013/049492, entitled “ANIMAL FEED PASTE COMPOSITIONS AND PROCESSES OF MAKING SAME,” filed Jul. 6, 2013, which claims the benefit of priority to U.S. Provisional Patent Application No. 61/672,636, entitled, “ANIMAL FEED PASTE COMPOSITIONS AND PROCESSES OF MAKING SAME,” filed Jul. 17, 2012. The aforementioned PCT application and US Provisional application are incorporated herein by reference in their entirety.

### BACKGROUND

Dried distillers grains (“DDG”) are a co-product of the corn-to-ethanol conversion process. DDG may be produced by drying whole stillage separated from the fermentation beer, which is produced during the corn-to-ethanol conversion process. According to typical processes, wherein corn starch is hydrolyzed using a cooking process resulting in sugar and fermentation beer is subject to a distillation process resulting in ethanol and whole stillage, components of the DDG are exposed to high temperatures (i.e., close to or above the boiling point of water) in both the cooking process and the distillation process.

### SUMMARY

The present disclosure relates to compositions, such as feed compositions, including feed paste compositions, which may be derived from feedstock-to-ethanol conversion processes, such as corn-to-ethanol conversion processes. The present disclosure also relates to processes of making such compositions, including feed compositions and feed paste compositions. In some embodiments, the feed paste compositions comprise yeast and fine solids (comprising unfermented corn endosperm). In some embodiments, the processes involve a feedstock-to-ethanol fermentation process using a multi-step separation (e.g. centrifugation) process to separate components post-fermentation.

In embodiments according to the disclosure, the compositions are produced from a starch-to-ethanol fermentation-based conversion process comprising a saccharification process that is conducted without cooking (i.e., a cold cook saccharification process that maintains the temperature below the starch gelatinization temperature so that saccharification occurs directly from raw native insoluble starch to soluble glucose while bypassing starch gelatinization conditions). In embodiments according to the disclosure, the protein feed compositions (i.e. components of the protein feed compositions which are derived from the fermentation beer) are separated from the fermentation beer prior to the ethanol distillation step. By using an ethanol fermentation process including a saccharification process that is conducted without cooking and by separating the composition from the fermentation beer prior to distillation, the resulting composition has a reduced total heat exposure as compared to if it were made using a conventional process (i.e. using an equivalent process except that the saccharification step is a cooking process and beer fermentation composition initially undergoes a distillation step). For example, in some embodiments, the compositions have a heat exposure of less than about 190° F., or less than about 180° F., or less than about 100° F. By reducing the total heat exposure as compared to conventional processes, compositions according to the present disclosure may have properties that are different from compositions produced according to conventional processes; for example, compositions according to the present disclosure may have increased lysine content as compared to compositions produced by conventional processes.

In embodiments according to the disclosure, the feed paste composition can be prepared by a process comprising the steps of: (a) fractionating corn to separate an endosperm fraction; (b) subjecting the endosperm fraction to a particle size reduction process to form reduced endosperm; (c) saccharifying the reduced endosperm using an enzyme composition to form one or more sugars; (d) fermenting the one or more sugars using a yeast to form a beer composition comprising: a liquid fraction comprising ethanol and water, and a solid fraction comprising yeast and distillers grain; wherein the saccharification and fermentation are conducted without cooking; (e) centrifuging the beer composition to separate it into a first composition comprising bulk solids and residual liquid fraction, and a second composition comprising fine solids and a major portion of the liquid fraction; (f) without distillation, centrifuging the second composition to form a feed paste composition comprising a majority of the fine solids along with residual liquid fraction; and a fourth composition comprising a majority of the liquid fraction along with residual fine solids; (g) optionally, at least partially drying the feed paste composition; and (h) optionally, adding water to the feed paste composition.

In embodiments according to the present disclosure, feed paste compositions comprise, on a dry weight basis, at least about 40% weight crude protein (or at least about 45% weight crude protein, or at least about 50% weight crude protein, or at least about 55% weight crude protein, or at least about 60% weight crude protein); up to about 20% weight crude fat; about 20% weight or less neutral detergent fiber; and at least about 2.55% weight lysine (or at least about 2.70% weight lysine, or at least about 2.80% weight lysine); wherein the composition has an average particle size of about 30 μm or less (or the composition has an average particle size of about 15 μm or less); and wherein the feed paste composition has a heat exposure less than compositions produced according to conventional processes, for example the feed paste compositions have a heat exposure less than about 190° F., or less than about 180° F., or less than about 170° F., or less than about 160° F., or less than about 150° F., or less than about 140° F., or less than about 130° F., or less than about 120° F., or less than about 110° F., or less than about 100° F.

In embodiments according to the disclosure, the processes include: separating a beer composition comprising a solids fraction and a liquids fraction into a first mixture comprising bulk solids (such as solids having an average particle size of greater than about 15 μm, or greater than about 30 μm) and a minority portion of the liquids fraction and a second mixture comprising fine solids (such as solids having an average particle size of about 15 μm or less, or of about 30 μm or less) and a majority portion of the liquids fraction, wherein the beer composition results from fermenting a starch-based feedstock; and, removing at least a portion of the liquid from the second mixture to produce a feed paste composition comprising the fine solids, wherein separating and removing are performed in a manner that reduces the overall heat exposure of the fine solids as compared to solely using distillation to separate beer components into ethanol and whole stillage (for example the process may be performed in a manner such that the fine solids are not exposed to temperatures of greater than about 190° F., greater than about 180° F., or greater than about 100° F.) In further embodiments, the process of producing the animal feed paste composition is performed in a manner that reduces the overall heat exposure of the fine solids as compared to a process for making DDG which is similar to the process for making the animal feed paste composition except that the DDG process uses a cooking process for saccharifying starch and a distillation process for separating beer components into ethanol and whole stillage. In other embodiments, separating the beer composition, removing at least a portion of the liquid from the second mixture, or both involve centrifuging (alone or in combination with another separation/removing process). In some embodiments, the process also includes optionally pretreating a starch-based feedstock, for example pre-treating corn, saccharifying the starch in the corn to produce sugar, fermenting the sugar to produce a beer composition comprising a solids fraction and a liquids fraction, wherein saccharifying and fermenting can occur simultaneously or stepwise. In some embodiments, the process also comprises drying the feed paste composition. In some embodiments, the process involves drying the feed composition and thereafter adding liquid to the resultant dried composition.

### DESCRIPTION OF DRAWINGS

FIG. 1 is a flow process diagram of an embodiment of a starch-based feedstock-to-ethanol conversion process in which certain methods according to this disclosure may be implemented and certain compositions according to this disclosure may be made.

### DETAILED DESCRIPTION

### Definitions

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrases “for example,” “such as,” “including” and the like are used herein, the phrase “and without limitation” is understood to follow unless explicitly stated otherwise.

The terms “comprising” and “including” and “involving” (and similarly “comprises” and “includes” and “involves”) are used interchangeably and mean the same thing. Specifically, each of the terms is defined consistent with the common United States patent law definition of “comprising” and is therefore interpreted to be an open term meaning “at least the following” and also interpreted not to exclude additional features, limitations, aspects, etc.

The term “about” is meant to account for variations due to experimental error or to permit deviations from the measurements that don't negatively impact the intended purpose. The term “substantially” is meant to permit deviations from the descriptive term that don't negatively impact the intended purpose. All measurements or numbers are implicitly understood to be modified by the word about, even if the measurement or number is not explicitly modified by the word about. All descriptive terms are implicitly understood to be modified by the word substantially, even if the descriptive term is not explicitly modified by the word substantially. For example, “wherein the feed paste composition is substantially made by a process wherein the solids fraction is exposed to temperatures no greater than about 190 F” is intended to encompass processes wherein the solids fraction may be temporarily exposed to temperatures greater than 190 F (but for example not as long as such solids fraction would be exposed to these temperatures according to a process for producing DDG employing a saccharification process using cooking and/or a distillation process) potentially as a means to avoid the claim limitations but without meaningful impact to the resulting animal feed paste composition (for example the resulting feed composition still has different properties than if it were made using the cooking and/or distillation process).

Where ever the terms “a” or “an” are used, “one or more” is understood, unless explicitly stated otherwise or such interpretation is nonsensical in context.

### Corn Fractionation

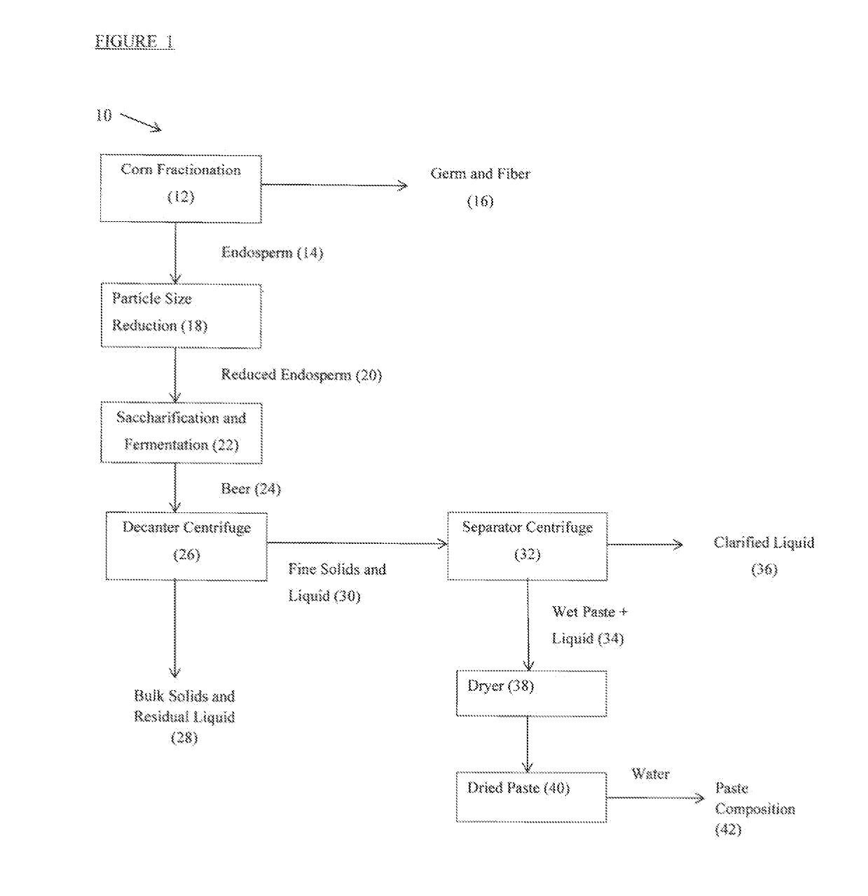

Referring to FIG. 1, in the first step of the process 10, a starch-based feedstock such as corn is sent to a fractionation process 12. In the fractionation process 12, the corn is separated into an endosperm fraction 14 and a germ/fiber fraction 16. Fractionation may be accomplished by any of a variety of methods and apparatus, such as those disclosed in U.S. Patent Application Publication No. 2004/0043117, the disclosure of which is incorporated herein by reference. Examples of suitable methods and apparatus for fractionation include a sieve, sieving, and elutriation. Further examples of suitable apparatus include a frictional mill such as a rice or grain polishing mill (e.g., those manufactured by Satake, Kett, or Rapsco). As used herein, the phrase “fractionated corn” refers to corn that includes only a portion or fraction of the total plant material, typically a material including starch.

Once fractionated the particle size of the separated endosperm 14 can be reduced by a variety of methods (e.g., by grinding to make the starch available for saccharification and fermentation). Other methods of endosperm reduction are available. For example, the endosperm can be ground with a ball mill, a roller mill, a hammer mill, or another mill known for grinding vegetable material, and/or other materials for the purposes of particle size reduction. The use of emulsion technology, rotary pulsation, and other means of particle size reduction can be employed to increase surface area of plant material (e.g., fractionated plant material) while raising the effectiveness of flowing the liquefied media. The prepared plant material (e.g., fractionated plant material) can be referred to as being or including “raw starch”.

As is known to one of skill in the art, a fine grind exposes more surface area of the endosperm, and can facilitate saccharification and fermentation. In an embodiment, the endosperm is ground so that a substantial portion (e.g., a majority of the ground endosperm) has a particle size of about 500 μm or less.

### Saccharification/Fermentation

After fractionation and particle size reduction, the reduced endosperm 20 is sent to a simultaneous saccharification and fermentation process 22 where the reduced endosperm 20 is converted to ethanol.

The saccharification process includes converting the fractionated corn endosperm to sugars that can then be fermented by a microorganism such as yeast to produce ethanol. This conversion can be effected by saccharifying the fractionated corn endosperm with any of a variety of known saccharifying enzyme compositions. In an embodiment, the saccharifying enzyme composition includes an amylase, such as an alpha amylase (e.g., an acid fungal amylase). In some embodiments, the enzyme composition also includes a glucoamylase.

In embodiments according to this disclosure, saccharification is conducted without cooking. As used herein, the term “without cooking” means maintaining a temperature below starch gelatinization temperature so that saccharification occurs directly from raw native insoluble starch to soluble glucose while bypassing starch gelatinization conditions. For example, saccharification can be conducted by mixing source of saccharifying enzyme composition, yeast, and fermentation ingredients with reduced corn endosperm and process waters without cooking.

As mentioned, the present process can include simultaneously converting reduced corn endosperm to sugars and fermenting those sugars with a microorganism such as yeast. Simultaneous saccharifying and fermenting can be conducted using the reagents and conditions described above for saccharifying and fermenting.

In certain embodiments, the present process can employ a glucoamylase. Glucoamylase is also known as amyloglucosidase and has the systematic name 1,4-alpha-D-glucan glucohydrolase (E.C. 3.2.1.3). Glucoamylase refers to an enzyme that removes successive glucose units from the non-reducing ends of starch. For example, certain glucoamylases can hydrolyze both the linear and branched glucosidic linkages of starch, amylose, and amylopectin. A variety of suitable glucoamylases are known and commercially available. For example, suppliers such as Novozymes and Genencor provide glucoamylases. The glucoamylase can be of fungal origin.

The amount of glucoamylase employed in the present process can vary according to the enzymatic activity of the amylase preparation.

In certain embodiments, the present process employs an alpha-amylase. The alpha-amylase can be one produced by fungi. The alpha-amylase can be one characterized by its ability to hydrolyze carbohydrates under acidic conditions. An amylase produced by fungi and able to hydrolyze carbohydrates under acidic conditions is referred to herein as acid fungal amylase, and is also known as an acid stable fungal alpha-amylase. Acid fungal amylase can catalyze the hydrolysis of partially hydrolyzed starch and large oligosaccharides to sugars such as glucose. The acid fungal amylase that can be employed in the present process can be characterized by its ability to aid the hydrolysis of raw or native starch, enhancing the saccharification provided by glucoamylase. In an embodiment, the acid fungal amylase produces more maltose than conventional (e.g., bacterial) alpha-amylases.

Examples of suitable acid fungal amylase can be isolated from any of a variety of fungal species, including Aspergillus, Rhizopus, Mucor, Candida, Coriolus, Endothia, Enthomophtora, Irpex, Penicillium, Sclerotium and Torulopsis species. In an embodiment, the acid fungal amylase is thermally stable and is isolated from Aspergillus species, such as A. niger, A. saitoi or A. oryzae, from Mucor species such as M. pusillus or M. miehei, or from Endothia species such as E. parasitica. In an embodiment, the acid fungal amylase is isolated from Aspergillus niger. The acid fungal amylase activity can be supplied as an activity in a glucoamylase preparation, or it can be added as a separate enzyme. A suitable acid fungal amylase can be obtained from Novozymes, for example in combination with glucoamylase.

The amount of acid fungal amylase employed in the present process can vary according to the enzymatic activity of the amylase preparation.

Examples of suitable liquids include water and a mixture of water and process waters, such as stillage (backset), scrubber water, evaporator condensate or distillate, side stripper water from distillation, or other ethanol plant process waters. In an embodiment, the liquid includes water. In an embodiment, the liquid includes water in a mixture with about 1 to about 70 vol-% stillage, about 15 to about 60 vol-% stillage, about 30 to about 50 vol-% stillage, or about 40 vol-% stillage.

Any of a variety of yeasts can be employed as the yeast starter in the present process. Examples of suitable yeasts include any of a variety of commercially available yeasts, such as commercial strains of Saccharomyces cerevisiae. Examples of suitable strains include “Fali” (Fleischmann's), Thermosac (Alltech), Ethanol Red (LeSafre), BioFerm AFT (North American Bioproducts), and the like. In an embodiment, the yeast is selected to provide rapid growth and fermentation rates in the presence of high temperature and high ethanol levels. In an embodiment, Fali yeast has been found to provide good performance as measured by final alcohol content of greater than 17% by volume. In some embodiments, the amount of yeast starter employed is selected to effectively produce a commercially significant quantity of ethanol in a suitable time (e.g., less than 75 hours).

In an embodiment, simultaneous saccharification and fermentation is conducted at a temperature of about 25 to about 40 C or about 30 C to about 35 C. In an embodiment, during saccharification and fermentation the temperature is decreased from about 40 C to about 25 C or from about 35 C to about 30 C during the first half of the saccharification, and the temperature is held at the lower temperature for the second half of the saccharification.

In an embodiment, saccharification and fermentation is conducted at a pH of about 6 or less, a pH of about 3 to about 6, about 3.5 to about 6, about 4 to about 5, about 4 to about 4.5, about 4.5 to about 5, or about 4.5 to about 4.8. The initial pH of the saccharification and fermentation mixture can be adjusted by addition of, for example, ammonia, sulfuric acid, phosphoric acid, process waters (e.g., stillage (backset), evaporator condensate (distillate), side stripper bottoms, and the like), and the like.

In an embodiment, saccharification and fermentation are conducted for about to 25 (e.g., 24) to about to 150 hours, about 25 (e.g., 24) to about 72 hours, about 45 to about 55 hours, about 50 (e.g., 48) to about 96 hours, about 50 to about 75 hours, or about 60 to about 70 hours. For example, saccharification and fermentation can be conducted for about 30, about 40, about 50, about 60, or about 70 hours. For example, saccharification and fermentation can be conducted for about 35, about 45, about 55, about 65, or about 75 hours.

In an embodiment, simultaneous saccharifying and fermenting can be carried out employing quantities of enzyme and yeast selected to maintain high concentrations of yeast and high levels of budding of the yeast in the fermentation broth. For example, the present process can employ quantities of enzyme and yeast selected to maintain yeast at or above about 200 cells/mL, at or above about 300 cells/mL, or at about 300 to about 600 cells/mL.

In an embodiment, simultaneous saccharifying and fermenting can be carried out employing quantities of enzyme and yeast selected to maintain low concentrations of soluble sugar in the fermentation broth. In an embodiment, simultaneous saccharifying and fermenting can be carried out employing quantities of enzyme and yeast selected to maintain low concentrations of glucose in the fermentation broth. For example, the present process can employ quantities of enzyme and yeast selected to maintain glucose at levels at or below about 2 wt-%, at or below about 1 wt-%, at or below about 0.5 wt-%, or at or below about 0.1 wt-%. For example, the present process can employ quantities of enzyme and yeast selected to maintain glucose at levels at or below about 2 wt-% during saccharifying and fermenting. For example, the present process can employ quantities of enzyme and yeast selected to maintain glucose at levels at or below about 2 wt-% from hours 0-10 (or from 0 to about 15% of the time) of saccharifying and fermenting. For example, the present process can employ quantities of enzyme and yeast selected to maintain glucose at levels at or below about 1 wt-%, at or below about 0.5 wt-%, or at or below about 0.1 wt-% from hours 12-54 (or from about 15% to about 80% of the time) of saccharifying and fermenting. For example, the present process can employ quantities of enzyme and yeast selected to maintain glucose at levels at or below about 1 wt-% from hours 54-66 (or about from 80% to about 100% of the time) of saccharifying and fermenting.

### Production of Feed Compositions

After saccharification/fermentation 22, components of the feed composition, which are derived from the resulting beer 24, are separated from the beer 24 in a manner that reduces the heat exposure of the components as compared to using the traditional distillation process to separate beer components (initially into ethanol and whole stillage). In some embodiments, the post-fermentation separation process is a multi-step separation process, comprising a first separation, and a second separation, such as a first centrifugation and a second centrifugation, for example as described below.

### First Separation Process

After the saccharification and fermentation process 22, the resulting beer 24 is sent to a first separation process 26. The first separation process 26 is configured to at least partially separate the bulk solids from the fine solids and liquids. In an embodiment of the invention, the first separation process 26 is conducted using a centrifuge, for example, a decanter centrifuge. A representative decanter centrifuge is commercially available under the trade designation “CB501” from Westfalia (Northvale, N.J.). In the decanter centrifuge, the beer 24 is separated into a bulk solids stream 28 and a fine solids stream 30. In some embodiments, the solids in the fine solids stream 30 comprise predominately yeast and unfermented corn endosperm particles, and the liquid in the fine solids stream 30 comprises ethanol, water, and may further include corn oil. Soluble species may also be present. In such embodiments, the bulk solids stream may comprise bulk solids along with a liquid fraction comprising ethanol and water.

In some embodiments, the centrifuge is adjusted so that the fine solids in fine solids stream 30 have an average particle size of about 30 μm or less, and the bulk solids in stream 28 have an average particle size of greater than about 30 μm. In some embodiments, the fine solids in fine solids stream 30 have an average particle size of about 15 μm or less, and the bulk solids in the stream 28 have an average particle size of greater than about 15 μm. The separation may be controlled, for example, by controlling the speed of the centrifuge and/or the flow rate of beer passing through the centrifuge.

After separation, the bulk solid stream 28 may be sent to a beer stripper in order to remove ethanol that is present in the liquid fraction. Following the beer stripper, the bulk solids steam may be sent to a centrifuge and dryer to remove at least a portion of the remaining residual water, or substantially all of the remaining residual water. In an alternative embodiment, the bulk solids stream 28 may be dried using the process reported, for example, in U.S. Patent Application No. 2010/0159514 (Redford), the disclosure of which is incorporated herein by reference.

### Second Separation Process

After the first separation step, the fine solids/liquid stream 30 may be fed to a second separation process 32. The second separation process 32 is configured to separate the fine solids from a major portion of the liquid in order to yield a wet paste stream 34 and a clarified (i.e., relatively free of solids) liquid stream 36. The wet paste stream 34 may comprise a majority of the fine solids along with residual liquid comprising mainly ethanol and water. In some embodiments, the wet paste stream comprises about 30% weight to about 40% weight solids. The fine solids may comprise yeast along with fine particles comprising unfermented corn endosperm. The clarified liquid stream 36 may comprise mainly ethanol and water and may further include corn oil and soluble species.

In an embodiment according to the disclosure, the second separation step is conducted using a centrifuge that is configured to separate fine solids from liquids. One useful centrifuge is commercially available under the trade designation “SEDICANTER 3E” from Flottweg AG (Germany). The centrifuge can be adjusted as known to one of skill in the art in order to separate the wet paste from the liquid stream.

### Drying Process

After the second separation step 32, the wet paste stream 34 may be dried to remove residual water and ethanol. In some embodiments, the wet paste stream 34 contains greater than about 50% weight total liquid (mainly ethanol and water). In some embodiments, the wet paste stream 34 is dried so that it comprises about 1% weight liquid or less. Optionally, water may be added back to the dried paste composition in order to provide an end-product having the desired moisture content. For example, water may be added to the dried paste to form a paste having about 8% weight to about 10% weight water.

### Compositions

As discussed herein, in some embodiments, the animal feed compositions according to this disclosure are produced using a feedstock-to-ethanol fermentation process wherein the total heat exposure of the feed compositions is reduced as compared to similar processes for producing DDG compositions, except in which distillation is used to initially separate the beer fermentation components (i.e. in which distillation is used to initially separate ethanol from whole stillage in the beer composition). In other embodiments, the animal feed compositions according to this disclosure are produced using a feedstock-to-ethanol fermentation process wherein the total heat exposure of the animal feed compositions is reduced as compared to a similar process for producing DDG compositions, except in which saccharification is performed using a cooking process. In yet other embodiments, the animal feed compositions according to this disclosure are produced according to a feedstock-to-ethanol fermentation process wherein the total heat exposure of the animal feed composition is reduced as compared to a similar process for producing DDG compositions except in which saccharification is performed using a cooking process and distillation is initially used to separate the beer fermentation components. As discussed herein, the feed paste compositions of the invention are produced using a process that limits total exposure to heat, for example reduces total exposure to heat as compared to processes for producing DDG that are similar to the process for producing the animal feed composition except that the DDG process uses a cooking process for saccharification and/or a distillation process to separate beer components. In some embodiments, the endosperm is not cooked to convert the starch into sugars and the feed paste composition is separated without passing through a distillation process.

In embodiments according to this disclosure, the animal feed paste compositions comprise, on a dry weight basis, about 40% weight or greater crude protein; up to about 20% weight crude fat; about 20% weight or less neutral detergent fiber; and about 2.55% weight or greater lysine; wherein the composition has an average particle size of about 30 μm or less; and wherein the feed paste composition has a heat exposure of less than about 190 F (e.g. the feed paste composition is made by a process wherein the solids component of the composition have not been substantially exposed to temperatures of about 190 F or greater).

In some embodiments, the animal feed paste compositions comprise fine solids having an average particle size of about 15 μm or less.

In some embodiments, the feed paste composition comprise, on a dry weight basis, about 40% weight or greater crude protein, or about 45% weight or greater crude protein, or about 55% weight or greater crude protein, or about 60% weight or greater crude protein.

In some embodiments, the animal feed paste compositions comprise, on a dry weight basis, about 2.55% weight or greater lysine, or about 2.70% weight or greater lysine, or about 2.80% weight or greater lysine.

### Additional Embodiments

A number of embodiments have been described but a person of skill understands that still other embodiments are encompassed by this disclosure. It is understood, therefore, that this disclosure and the inventive concepts are not limited to the particular embodiments disclosed, but are intended to cover modifications within the spirit and scope of the inventive concepts including as defined in the appended claims. Accordingly, the foregoing description of various embodiments does not necessarily imply exclusion. For example, “some” embodiments or “other” embodiments may include all or part of “some”, “other,” “further,” and “certain” embodiments within the scope of this invention. Non-limiting methods and compositions within the scope of the disclosure can also be defined in accordance with the below embodiments.

1. A process of making an animal feed paste composition having a low heat exposure, the process comprising the steps of:
(a) fractionating corn to separate an endosperm fraction;
(b) subjecting the endosperm fraction to a particle size reduction process to form reduced endosperm;
(c) saccharifying the reduced endosperm using an enzyme composition to form one or more sugars;
(d) fermenting the one or more sugars using a yeast to form a beer composition comprising: a liquid fraction comprising ethanol and water, and a solid fraction comprising yeast and distillers grain; wherein the saccharification and fermentation are conducted without cooking;
(e) centrifuging the beer composition to separate it into a first composition comprising bulk solids and residual liquid fraction, and a second composition comprising fine solids and a major portion of the liquid fraction;
(f) prior to distillation, centrifuging the second composition to form a feed paste composition having a low heat exposure, the feed paste composition comprising a majority of the fine solids along with residual liquid fraction; and a fourth composition comprising a majority of the liquid fraction along with residual fine solids;
(g) optionally, at least partially drying the feed paste composition; and
(h) optionally, adding water to the feed paste composition.
   2. The process of embodiment 1, wherein the fine solids have an average particle size of about 30 μm or less.
   3. The process of embodiment 1, wherein the fine solids have an average particle size of about 15 μm or less.
   4. The process of embodiment 1, wherein the feed paste composition comprises, on a dry weight basis, about 40% weight or greater crude protein.
   5. The process of embodiment 1, wherein the feed paste composition comprises, on a dry weight basis, about 45% weight or greater crude protein.
   6. The process of embodiment 1, wherein the feed paste composition comprises, on a dry weight basis, about 55% weight or greater crude protein.
   7. The process of embodiment 1, wherein the feed paste composition comprises, on a dry weight basis, about 60% weight or greater crude protein.
   8. The process of embodiment 1, wherein the feed paste composition comprises, on a dry weight basis, about 2.55% weight or greater lysine.
   9. The process of embodiment 1, wherein the feed paste composition comprises, on a dry weight basis, about 2.70% weight or greater lysine.
   10. The process of embodiment 1, wherein the feed paste composition comprises, on a dry weight basis, about 2.80% weight or greater lysine.
   11. The process of embodiment 1, wherein the feed paste composition has a heat exposure of about 190° F. or less.
   12. The process of embodiment 1, wherein the feed paste composition has a heat exposure of about 180° F. or less.
   13. The process of embodiment 1, wherein the feed paste composition has a heat exposure of about 100° F. or less.
   14. The process of embodiment 1, wherein the saccharification and fermentation are conducted simultaneously and without cooking
   15. The process of embodiment 14, wherein the simultaneous saccharification and fermentation are conducted at a temperature of about 100° F. or less.
   16. The process of embodiment 1, wherein the feed paste composition comprises, on a dry weight basis, about 40% weight or greater crude protein; up to about 20% weight crude fat; about 20% weight or less neutral detergent fiber; and about 2.55% or greater lysine; wherein the feed paste composition has an average particle size of about 30 μm or less; and wherein the feed paste composition has a heat exposure of less than about 190° F.
   17. The process of embodiment 1, wherein the enzyme composition comprises one or more of a glucoamylase, an alpha-amylase, or a mixture thereof
   18. An animal feed paste composition comprising, on a dry weight basis, about 40% weight or greater crude protein; up to about 20% weight crude fat; about 20% weight or less neutral detergent fiber; and about 2.55% weight or greater lysine; wherein the composition has an average particle size of about 30 um or less; and wherein the feed paste composition has a heat exposure of less than about 190 F.
   19. The animal feed paste composition of embodiment 18, wherein the fine solids have an average particle size of about 15 μm or less.
   21. The animal feed paste composition of embodiment 18, wherein the feed paste composition comprises, on a dry weight basis, about 45% weight or greater crude protein.
   22. The animal feed paste composition of embodiment 18, wherein the feed paste composition comprises, on a dry weight basis, about 55% weight or greater crude protein.
   23. The animal feed paste composition of embodiment 18, wherein the feed paste composition comprises, on a dry weight basis, about 60% weight or greater crude protein.
   25. The animal feed paste composition of embodiment 18, wherein the feed paste composition comprises, on a dry weight basis, about 2.70% weight or greater lysine.
   26. The animal feed paste composition of embodiment 18, wherein the feed paste composition comprises, on a dry weight basis, about 2.80% weight or greater lysine.
   27. The animal feed paste composition of embodiment 18, wherein the feed paste composition has a temperature exposure of about 180° F. or less.
   28. The animal feed paste composition of embodiment 18, wherein the feed paste composition has a temperature exposure of about 100° F. or less.
   29. A process, comprising:
a. separating a beer composition comprising a solids fraction and a liquids fraction into a first mixture comprising bulk solids and a minority portion of the liquids fraction and a second mixture comprising fine solids and majority portion of the liquids fraction, wherein the beer composition results from fermenting a starch-based feedstock; and,
b. removing at least a portion of the liquid from the second mixture to produce a feed paste composition comprising the fine solids, wherein separating and removing are performed in a manner that reduces the total heat exposure of the fine solids as compared to solely using distillation to separate beer components into ethanol and whole stillage.
   30. A process according to embodiment 29, wherein separating and removing are performed in a manner that reduces the total heat exposure of the fine solids as compared to a process for making DDG using both a saccharification cooking process and a distillation process to separate beer components into ethanol and whole stillage
   31. A process according to either or embodiments 29 or 30, wherein separating is substantially performed at temperatures below the vaporization temperature of ethanol.
   32. A process according to any of embodiments 29-31, wherein removing is substantially performed at temperatures below the vaporization temperature of ethanol.
   33. A process according to any of embodiments 29-32, wherein separating comprises centrifuging.
   34. A process according any of embodiments 29-33, wherein removing comprises centrifuging.
   35. A process according to any of embodiments 29-34, wherein separating and removing are performed without any, and prior to any, distillation.
   36. A process according to any of embodiments 29-35, wherein the first mixture comprises bulk solids and a residual portion of the liquids fraction and the second mixture comprises fine solids and a major portion of the liquids fraction.
   37. A process according to any of embodiments 29-36, wherein removing comprises removing a major portion of the liquids fraction resulting in the feed paste composition comprising fine solids and a residual portion of the liquids fraction.
   38. A process according to any of embodiments 29-37, further comprising:
a. saccharifying starch derived from a starch-based feedstock to sugar without cooking the starch; and,
b. fermenting the sugar to produce the beer composition, wherein saccharifying and fermenting can occur step-wise or simultaneously.
   39. A process according to any of embodiments 29-38, further comprising drying the feed paste composition.
   40. A process according to embodiment 39, wherein the dried feed paste composition comprises no more than about 1% by weight liquid.
   41. A process according to either of embodiments 39 or 40, further comprising adding liquid to the dried feed paste composition.
   42. A process according to either of embodiments 39 or 41, wherein the feed paste composition comprises an amount of liquid ranging from about 8% to about 10% by weight.
   43. A process according to any of embodiments 29-38, wherein the feed paste composition comprises an amount of solids ranging from about 30% to about 40% by weight.
   44. A process according to any of embodiments 29-43, wherein the bulk solids have an average particle size of greater than about 30 μm and the fine solids have an average particle size of about 30 μm or less.
   45. A process according to any of embodiments 29-43, wherein the bulk solids have an average particle size of greater than about 15 μm and the fine solids have an average particle size of about 15 μm or less.
   46. A process according to any of embodiments 29-45, wherein the fine solids are exposed to temperatures no greater than about 190° F., the bulk solids are exposed to temperatures no greater than about 190° F., or both the fine solids and the bulk solids are exposed to temperatures no greater than about 190° F.
   47. A process according to embodiment 46, wherein the fine solids are exposed to temperatures no greater than about 180° F., the bulk solids are exposed to temperatures no greater than about 180° F., or both the fine solids and the bulk solids are exposed to temperatures no greater than about 180° F.
   48. A process according to embodiment 47, wherein the fine solids are exposed to temperatures no greater than about 100° F., the bulk solids are exposed to temperatures no greater than about 100° F., or both the fine solids and the bulk solids are exposed to temperatures no greater than about 100° F.
   49. A process according to any of embodiments 29-48, wherein the feed paste composition comprises, on a dry weight basis:
a. crude protein in an amount of at least about 40 weight %, at least about 45 weight %, at least about 50 weight %, at least about 55 weight %, or at least about 60 weight %;
b. crude fat in an amount of up to about 20 weight %;
c. neutral detergent fiber in an amount of up to about 20 weight %; and,
d. lysine in an amount of at least about 2.55 weight %, at least about 2.70 weight %, or at least about 2.80 weight %.
   50. An animal feed paste composition comprising a solids fraction, comprising: on a dry weight basis,
a. about 40% weight or greater crude protein, about 45% weight or greater crude protein, about 50% weight or greater crude protein, about 55% weight or greater crude protein, or about 60% weight or greater crude protein;
b. up to about 20% weight crude fat;
c. about 20% weight or less neutral detergent fiber; and,
d. about 2.55% weight or greater lysine, about 2.70% weight or greater lysine, or about 2.80% weight or greater lysine; wherein the feed paste composition was substantially made by a process wherein the solids fraction was exposed to temperatures no greater than about 190 F.
   51. An animal feed paste composition according to embodiment 50, wherein the animal feed paste composition is derived from a starch-based feedstock-to-ethanol conversion process.
   52. An animal feed paste composition according to embodiment 51, wherein the starch-based feedstock is corn.
   53. An animal feed paste composition according to any of embodiments 50-52, wherein the solids fraction was exposed to temperatures no greater than about 180 F.
   54. An animal feed paste composition according embodiment 53, wherein the solids fraction was exposed to temperatures no greater than about 100 F.
   55. An animal feed paste composition according to any of embodiments 50-54, wherein the solids fraction has an average particle size of no greater than about 30 μm.
   56. An animal feed paste composition according to embodiment 55, wherein the solids fraction has an average particle size of no greater than about 15 μm.

What is claimed is:

1. A process, comprising:
a. separating a beer composition comprising a solids fraction and a liquids fraction into a first mixture comprising bulk solids and a minority portion of the liquids fraction and a second mixture comprising fine solids and a majority portion of the liquids fraction, wherein the beer composition results from fermenting a starch-based feedstock; and,
b. removing at least a portion of the liquid from the second mixture to produce a feed paste composition comprising the fine solids, wherein separating and removing are performed in a manner that reduces the total heat exposure of the fine solids as compared to solely using distillation to separate beer components.

2. A process according to claim 1, wherein separating and removing are substantially performed at temperatures below the vaporization temperature of ethanol.

3. A process according to claim 1, wherein the separating and removing are performed in a manner that reduces the total heat exposure of the fine solids as compared to a process for producing Dried Distiller's Grains that uses a cooking process for saccharification and distillation to separate beer components into ethanol and whole stillage.

4. A process according to claim 1, wherein separating means centrifuging, removing means centrifuging, or both

5. A process according to claim 1, wherein separating and removing are performed without any, and prior to any, distillation.

6. A process according to claim 1, wherein the first mixture comprises bulk solids and a residual portion of the liquids fraction and the second mixture comprises fine solids and a major portion of the liquids fraction.

7. A process according to either of claim 1, wherein removing comprises removing a major portion of the liquids fraction resulting in the feed paste composition comprising fine solids and a residual portion of the liquids fraction.

8. A process according to claim 1, further comprising:
a. saccharifying starch derived from a starch-based feedstock to sugar without cooking the starch; and,
b. fermenting the sugar to produce the beer composition, wherein saccharifying and fermenting can occur step-wise or simultaneously.

9. A process according to claim 1, further comprising drying the feed paste composition.

10. A process according to claim 9, wherein the dried feed paste composition comprises no more than about 1% by weight liquid.

11. A process according to claim 10, further comprising adding liquid to the dried feed paste composition.

12. A process according to claim 11, wherein the feed paste composition comprises an amount of liquid ranging from about 8% to about 10% by weight.

13. A process according to claim 1, wherein the feed paste composition comprises an amount of solids ranging from about 30% to about 40% by weight.

14. An animal feed paste composition comprising: on a dry weight basis,
a. about 40% weight or greater crude protein;
b. up to about 20% weight crude fat;
c. about 20% weight or less neutral detergent fiber; and,
d. about 2.55% weight or greater lysine; wherein the feed paste composition is derived from a starch-based feedstock-to-ethanol fermentation conversion process in which components of the composition are exposed to temperatures no greater than about 190 F.

15. An animal feed paste composition according to claim 14, wherein the starch-based feedstock-to-ethanol conversion process comprises saccharifying starch to sugar without cooking and separating fermentation beer components without distillation.

16. An animal feed paste composition according to claim 15, wherein the starch-based feedstock is corn.

17. An animal feed paste composition according to claim 14, wherein the solids fraction was exposed to temperatures no greater than about 180 F.

18. An animal feed paste composition according to claim 17, wherein the solids fraction was exposed to temperatures no greater than about 100 F.

19. An animal feed paste composition according to claim 15, wherein the solids fraction has an average particle size of no greater than about 30 μm.

20. An animal feed paste composition according to claim 19, wherein the solids fraction has an average particle size of no greater than about 15 μm.
